(19) United States
(12) Patent Application Publication
(10) Pub. No.: US 2009/0159763 A1
(43) Pub. Date: Jun. 25, 2009

(54) PORTABLE LAPTOP STAND

(76) Inventor: Sang Kwon Kim, Culver City, CA (US)

Correspondence Address: BUUS, KIM, KUO, & TRAN, APC, 4675 MacArthur Court, Suite 590, Newport Beach, CA, 92660, US

(21) Appl. No.: 11/961,979

(22) Filed: Dec. 20, 2007

(51) Int. Cl. F16M 11/00

(52) U.S. Cl. 248/174; 248/176.1

(57) ABSTRACT

A portable laptop stand comprising a generally rectangular flat board having a longitudinal axis perpendicular to a width of the board; said board having a distal end; said board having a proximal end; said board having a first portion, a second portion pivotably coupled to the first portion, and a main body pivotably coupled to the second portion; wherein the first portion has a longitudinal axis that is perpendicular to the longitudinal axis of the board; wherein the second portion has a longitudinal axis that is perpendicular to the longitudinal axis of the board; wherein said first portion is capable of folding back towards the main body and contact the main body. The board having a first attachment means disposed on the first portion; and a second attachment means disposed on the main body to detachably attach to said first attachment means.

### BACKGROUND OF INVENTION

1. Field of the Invention

The present invention generally relates to laptop computer stands, in particular, to a simple, portable, lightweight and relatively inexpensive laptop computer stand.

2. Description of the Prior Art

A laptop stand is commonly used to support a personal laptop computer to increase the comfortability and stability of use of the laptop computer by the user. As one can appreciate, many configurations exists regarding different types of laptop stands that include such prior registered patents such as U.S. Pat. No. 5,209,452 (Goldberg), U.S. Pat. No. 6,913,238 (Bakker et al.), U.S. Pat. No. 6,819,548 (Hillis et al.) and U.S. Pat. No. 6,352,233 (Barberich), all hereby incorporated by reference.

However, many adjustable and collapsible laptop stands involve numerous moving parts including a variety of pins, bolts, screws, and other moving parts that increase the chance of malfunction and breakage. Additionally, many current adjustable and collapsible laptop stands are expensive to manufacture and difficult to transport due to the size and weight of the laptop stands.

While these devices may be suitable for the particular purpose to which they address, they are not suitable for incorporating the advantages of a fully adjustable and collapsible laptop stand that has few, if any, moving parts to reduce malfunction and breakage and is relatively lightweight to increase portability and is relatively inexpensive to manufacture.

In these respects, the portable laptop stand according to the present invention substantially departs from the conventional concepts and designs of the prior art, and in so doing provides a portable laptop stand that is not anticipated, rendered obvious, suggested, or even implied by any of the prior art laptop stands, either alone or in combination thereof.

### SUMMARY OF THE INVENTION

In view of the foregoing disadvantages inherent in the known types of portable laptop stands now present in the prior art, the general purpose of the present invention, which will be described subsequently in greater detail, is to provide a portable laptop stand which allows more desirable kind of adjustability, collapsibility and portability than is provided in the patented constructions described above. Further, the present invention achieves the desired characteristics using fewer parts than required in the above designs described above. Indeed, the present invention's construction does not require screws, bolts, pins or nuts.

Another objective of the present invention is to provide a portable laptop stand that is relatively inexpensive to manufacture.

Another objective of the present invention is to provide a portable laptop stand that is comprised of pliable material that is relatively easy to manipulate, in particular, to bend, fold and collapse.

Another objective of the present invention is to provide improved flexible clamping or gripping ends which have increased contact surface that conforms to the instrument body edge so as to reduce the chance of unwanted instrument body slippage.

To attain this, the present invention generally comprises a generally rectangular flat board having a longitudinal axis perpendicular to a width of the board; said board having a distal end; said board having a proximal end; said board having a first portion, a second portion pivotably coupled to the first portion, and a main body pivotably coupled to the second portion; wherein the first portion has a longitudinal axis that is perpendicular to the longitudinal axis of the board; wherein the second portion has a longitudinal axis that is perpendicular to the longitudinal axis of the board; wherein said first portion is capable of folding back towards the main body and contact the main body. The board having a first attachment means disposed on the first portion; and a second attachment means disposed on the main body to detachably attach to said first attachment means.

The portable laptop stand of the present invention also comprising a first crease of linear depression in the board perpendicular to the longitudinal axis of the board and wherein first said first crease distinguishes said first portion from said second portion and wherein said first crease allows said first portion to be pivotably attached to said second portion. The present invention further comprising a second crease of linear depression in the board perpendicular to the longitudinal axis of the board, wherein said second crease distinguishes said second portion from said main body and wherein said second crease allows said second portion to be pivotably attached to said main body. The first attachment on said first portion comprising of at least one protrusion disposed at the distal end, and wherein said second attachment means is at least one receiving structure disposed on said main body. The protrusion being a tab structure extending from the distal end in a distal direction and wherein said receiving structure is a slit opening. The portable laptop stand of the present invention is formed by coupling the tab structure of the first attachment means into the receiving slits of the second attachment means whereby creating a triangular-like base. The portable laptop of the present invention also comprising of a plurality of adjustable anti-slip pads which are positioned on the main body.

In one preferred embodiment, the present invention further includes a board made of at least one member selected from the group consisting of card board, plastic, natural, wood, paper, synthetic material, metal, and metal alloy.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

To accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the portable laptop stand in its flat;

FIG. 2 is a perspective view of the portable laptop stand being manipulated into working position;

FIG. 3 is a perspective view of the portable laptop stand portraying the tab protrusions; connecting into the slit openings contained on the main body;

FIG. 4 is a perspective view of the portable laptop stand in its normal working position and portraying the ability to re-position the plurality of anti-slip pads;

FIG. 5 is a perspective view of the portable laptop stand in its normal working position;

FIG. 6 is a 45 degree top down perspective view of the portable laptop stand in normal working position;

FIG. 7 is a perspective view of the portable laptop stand depicting typical use with a laptop computer;

FIG. 8 is a side view of the portable laptop stand depicting typical use with a laptop computer;

FIG. 9 is a top down view of the portable laptop stand in its flat position;

FIG. 10 is a front view of the portable laptop stand in its normal working position;

FIG. 11 is a back view of the portable laptop stand in its normal working position;

FIG. 12A-G are views of alternate embodiments of the present invention.

### DETAILED DESCRIPTION OF THE INVENTION

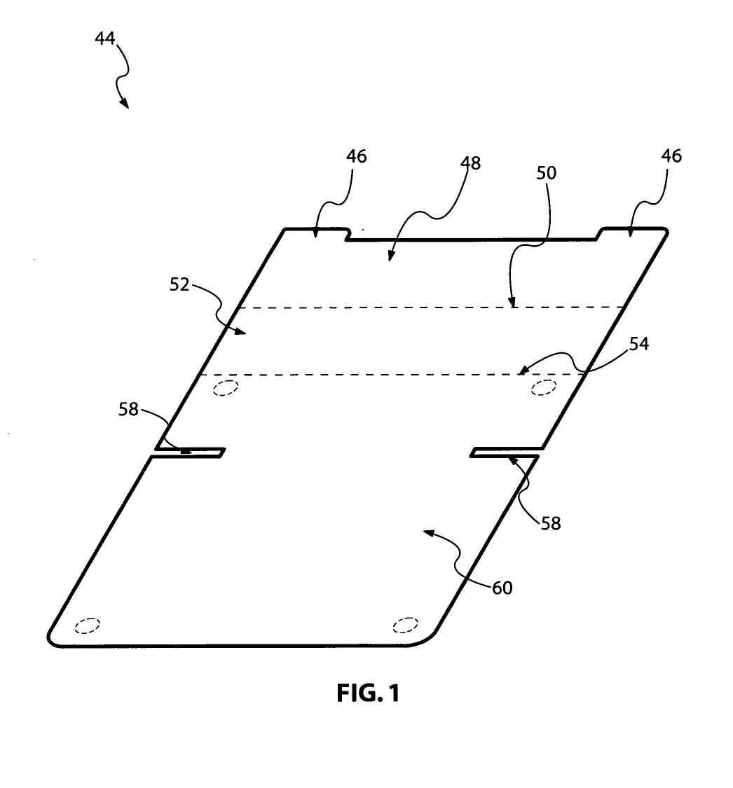

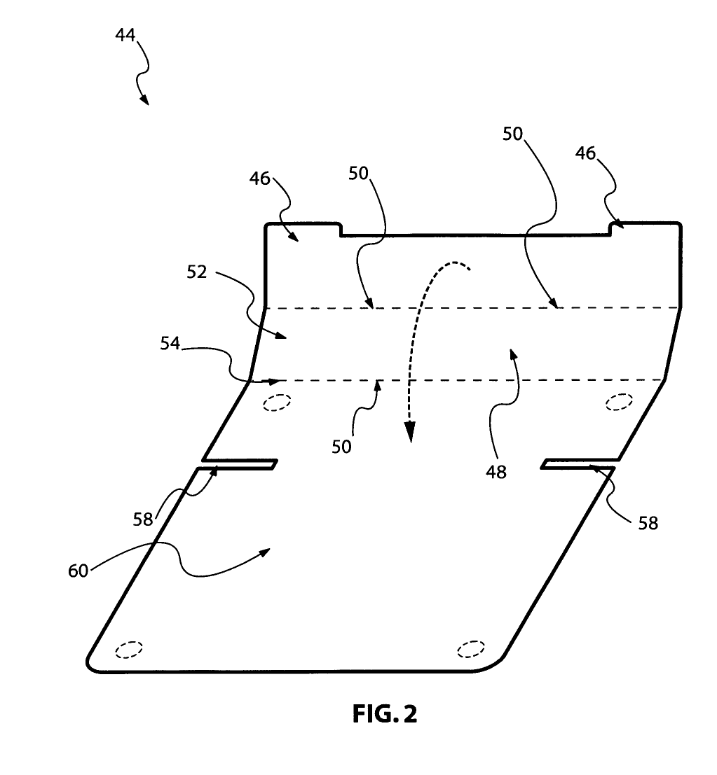

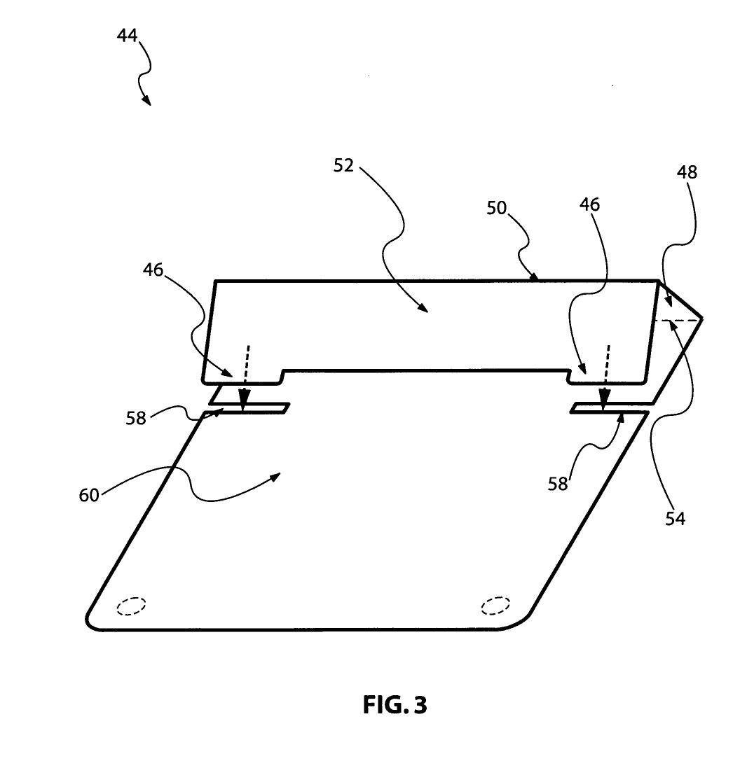

Turning now to the embodiment of FIG. 1, the portable laptop stand 44 of the present invention comprises a generally rectangular flat board 60 with a distal end and proximate end, said board having a first portion 48 and a second portion 52 that is pivotably coupled to said first portion 48. The first portion 48 having a longitudinal axis that is perpendicular to the longitudinal axis of the board and wherein the second portion 52 also having a longitudinal axis that is perpendicular to the longitudinal axis of the board. As shown in FIG. 2, a first and second crease 50 and 54 allows the first portion 48 of being capable of folding back towards the main body 60 and contacting the main body 60. In typical use, the user would urge the first portion 48 containing a first attachment means 46 onto the second attachment means 58 to securely connect the first portion 48 to the main body 60 as clearly illustrated in FIG. 3. In one preferred embodiment, the first attachment means comprises of a tab 46 protruding from the distal end of the first portion 48 and the second attachment means 58 comprises of at least one slit opening recess contained on the main body 60. This connection allows the portable laptop stand to operate in its normal working mode.

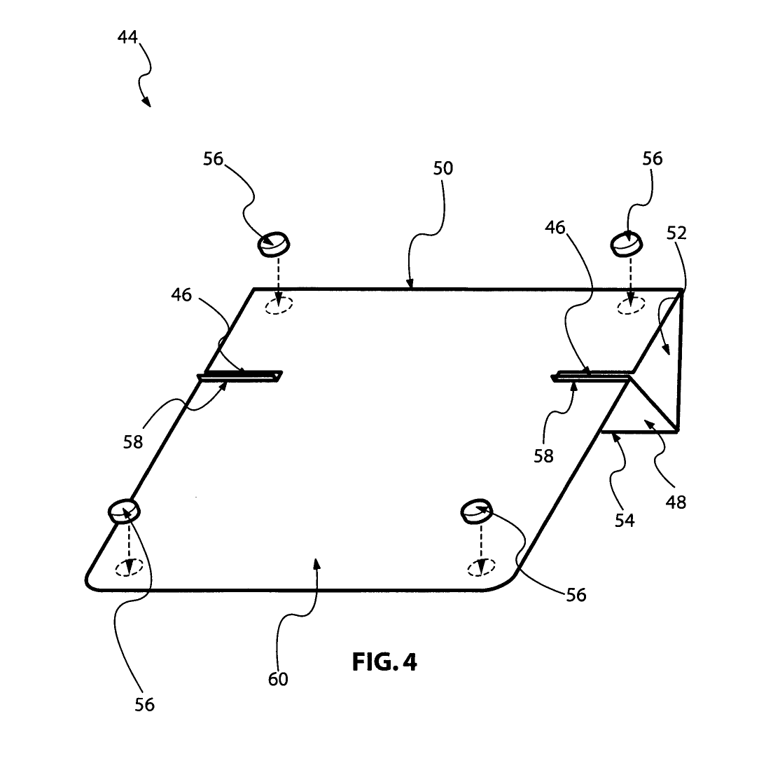

As shown in the FIG. 4, the portable laptop stand 44 contains a plurality of adjustable anti-skid pads 56 that can be adjusted and re-positioned to a desirable position.

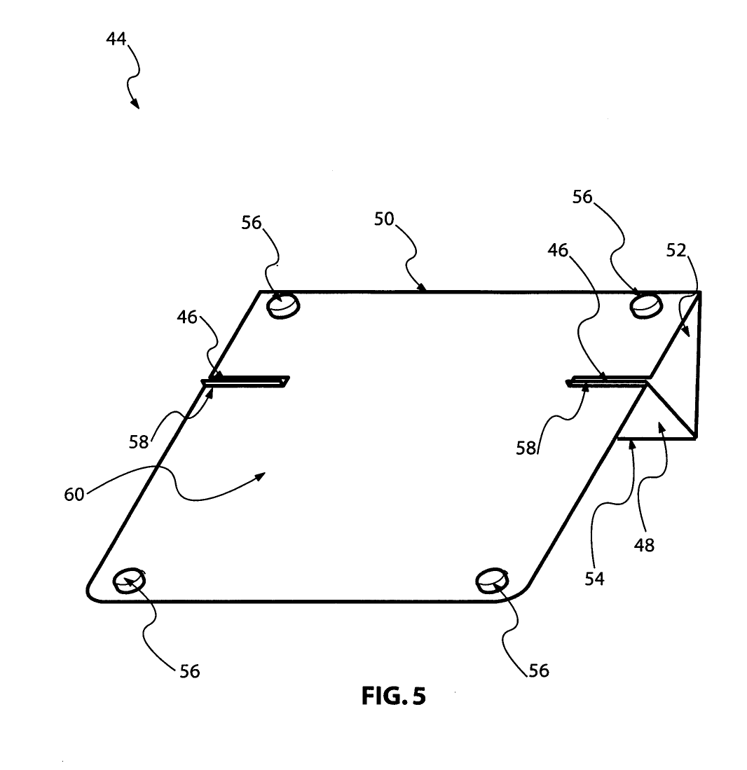

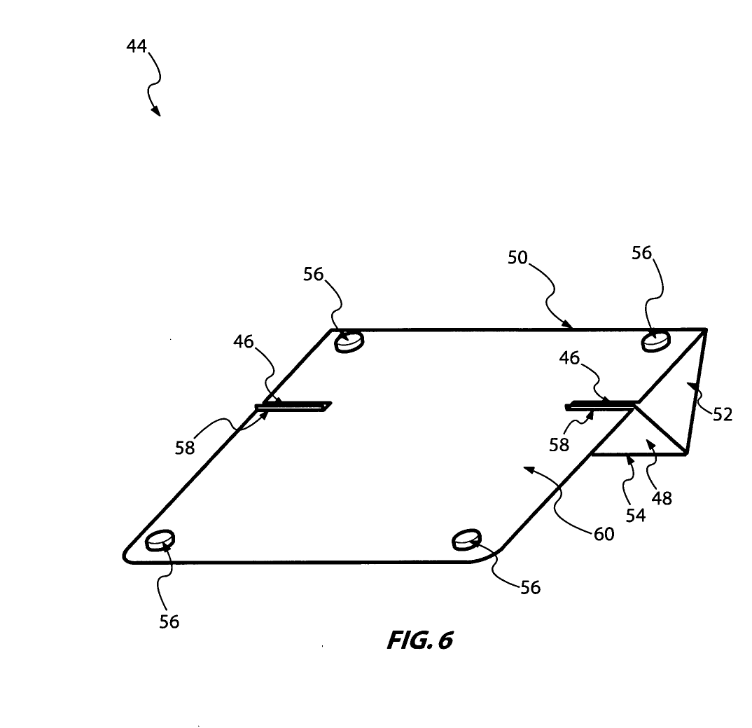

Turning to FIGS. 5 and 6, the portable laptop stand 44 is depicted in its normal operation mode with the plurality of adjustable anti-skid pads 56 facing up in order to contact the bottom of the user's laptop device.

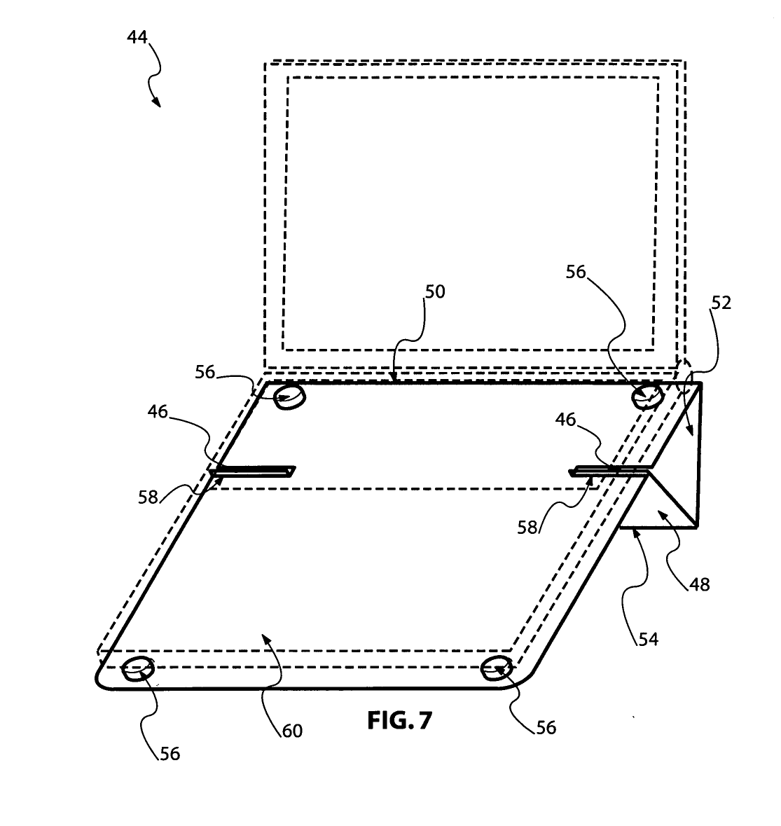

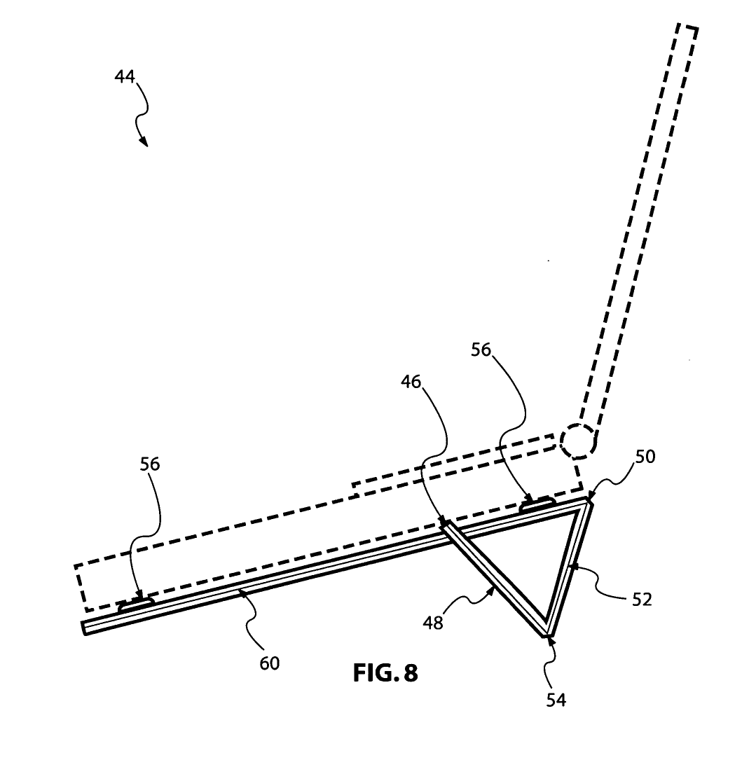

FIGS. 7 and 8 demonstrate one preferred embodiment and potential setup of positioning a normal laptop computer onto the portable laptop stand of the present invention.

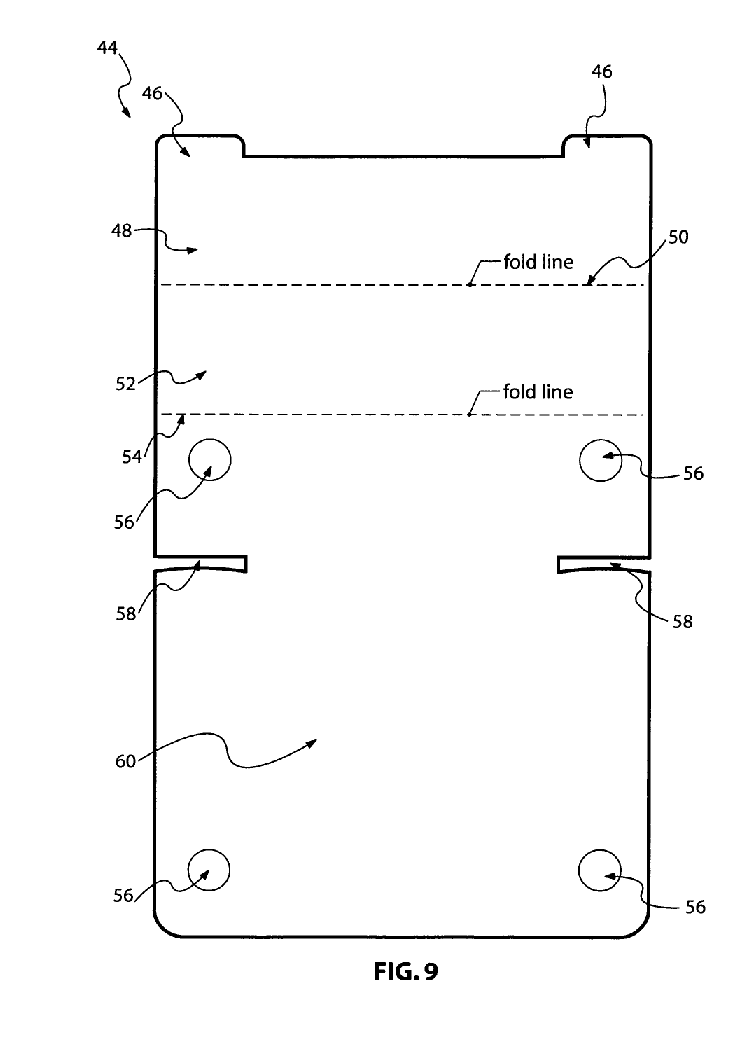

FIG. 9 provides a close up top down view of the portable laptop stand 44 of the present invention in its un-folded or flat position. In the preferred embodiment, the main board 60, first portion 48, and second portion 52 can be manufactured from a group consisting of cardboard, plastic, natural, wood, paper, synthetic material, metal and metal alloy.

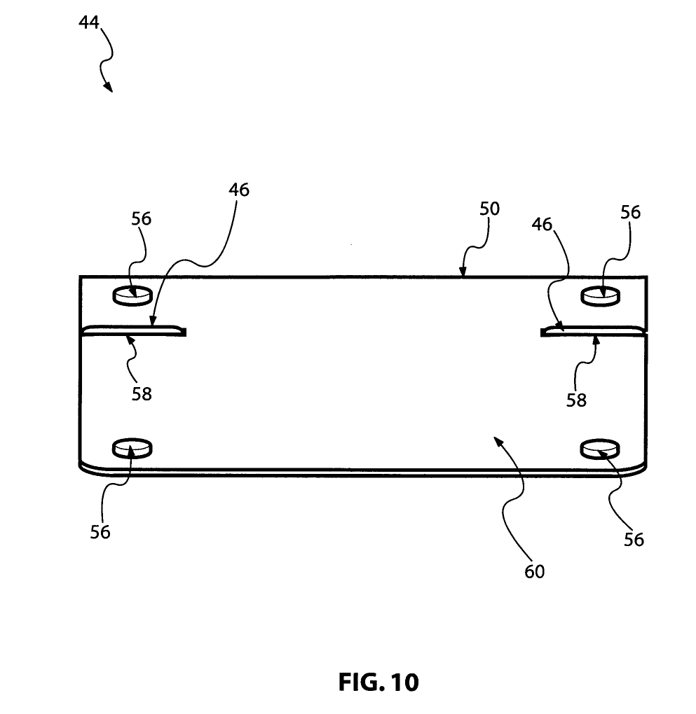

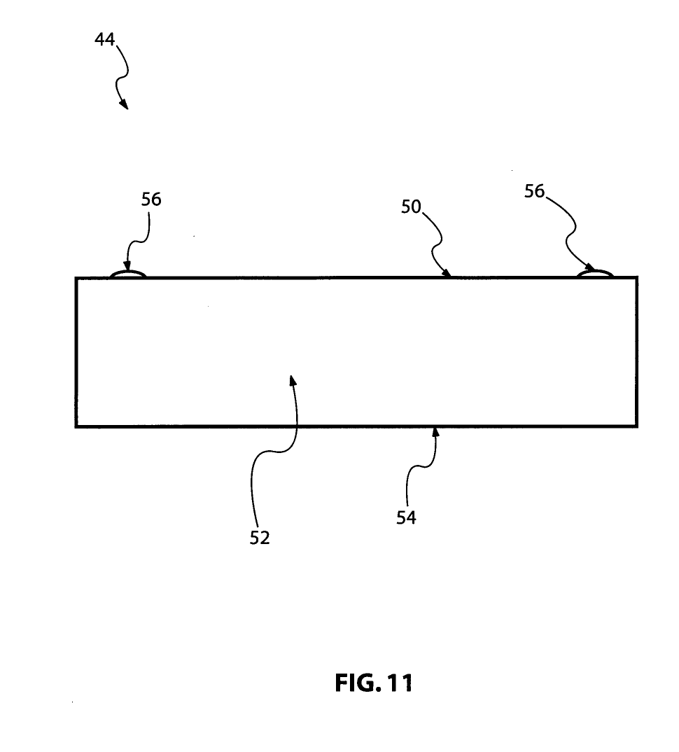

FIGS. 10 and 11 illustrate the portable laptop stand of the present invention from a front and back view.

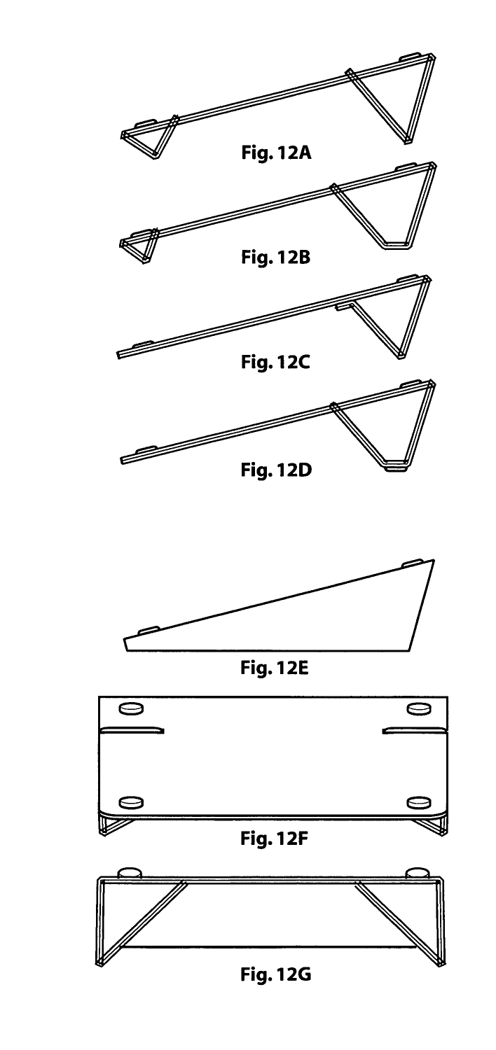

FIGS. 12A-12G illustrates alternative embodiments of the portable laptop stand of the present invention. As clearly seen, a variety of different configurations exist for the present invention including multiple variations of the triangular base and plurality of anti-slip pads.

Thus, specific embodiments and applications of the portable laptop stand have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A foldable stand having a folded configuration for holding or displaying a laptop computer, comprising:
a flat board having a longitudinal axis perpendicular to a width of the board;
said board having a distal end;
said board having a proximal end, wherein the proximal end does not contact the distal end when the foldable stand is in the folded configuration;
said board having a first portion, a second portion pivotably coupled to the first portion, and a main body pivotably coupled to the second portion, and wherein the first portion the second portion, and the main body each has a plane;
wherein the first portion has a longitudinal axis that is perpendicular to the longitudinal axis of the board;
wherein the second portion has a longitudinal axis that is perpendicular to the longitudinal axis of the board;
wherein the folded configuration forms a triangular prism on a bottom side of the main body, said triangular prism consists of the first portion, the second portion, and only a part of the main body and not the entire main body;
wherein said first portion folds back toward the main body and contact the main body to assume the folded configuration to support a weight of the laptop computer that is placed on a top side of the main body, when the foldable stand is placed on a solid surface with the bottom side of the main body facing downwards, and no planes of the first portion, the second portion, and the main portion are in direct contact with the solid surface;
a first attachment means disposed on the first portion; and
a second attachment means disposed on the main body to detachably attach to said first attachment means.

2. The foldable stand as recited in claim 1, wherein the board is made of at least one member selected from the group consisting of card board, plastic, natural, wood, paper, synthetic material, metal, and metal alloy.

3. The foldable stand as recited in claim 2, wherein the board is made of card board, and said first portion, second portion, and the main body are made of one single integral piece of card board.

4. The foldable stand as recited in claim 3 further comprising:
a first crease of linear depression in the board perpendicular to the longitudinal axis of the board;
wherein said first crease distinguishes said first portion from said second portion; and
wherein said first crease allows said first portion to be pivotably attached to said second portion.

5. The foldable stand as recited in claim 4 further comprising:
a second crease of linear depression in the board perpendicular to the longitudinal axis of the board;
wherein said second crease distinguishes said second portion from said main body; and
wherein said second crease allows said second portion to be pivotably attached to said main body.

6. The foldable stand as recited in claim 5, wherein said first attachment means and second attachment means are comprised of at least one of:
a. a protrusion disposed at the distal end, and a receiving structure on said main body;
b. adhesives;
c. adhesive tapes;
d. hook and loop connectors;
e. tongue and groove structures;
f. magnets; and
g. indentations.

7. The foldable stand as recited in claim 6, wherein said protrusion is a tab structure extending from the distal end in a distal direction, and wherein said receiving structure is a slit opening.

8. The foldable stand as recited in claim 7, wherein a plurality of holes are disposed on said main body.

9. A portable laptop stand, comprising:
a flat base portion;
a support portion collapsibly coupled to the base portion;
at least four anti-skid pads attached to the stand to contact the bottom of a bottom of a laptop;
wherein the support portion is capable of collapsing into a low profile such that the entire laptop stand is substantially planar.

10. The portable laptop stand as recited in claim 9, wherein the support portion is comprised of a first piece pivotably coupled to a second piece, and when collapsed, said first piece, second piece, and said support portion are aligned in a serial fashion.

11. The portable laptop stand as recited in claim 9, wherein when the support portion is assembled, said second piece is coupled to the base portion, and said first piece makes detachable contact with the base portion via at least one coupler.

12. The portable laptop stand as recited in claim 11 furthering comprising two slits on the base portion, and wherein the first piece has at least one coupler that is a tab extending from the first piece.

13. The portable laptop stand as recited in claim 11, wherein the base portion has a plurality of anti-slip pads adhered to at least one of the base portion and the flat base portion

14. The portable laptop stand as recited in claim 12, wherein when assembled, the support portion and a part of the base portion forms a triangular prism.

15. A product of portable and collapsible laptop stand, the product comprising:
a written instruction to assemble board pieces into the stand so that a laptop may be rested on top of the stand;
a plurality of adjustable anti-skid pads with instruction to adhere said pads onto the laptop stand to contact a bottom of a laptop; and
a board with sections coupled together such that when these sections are assembled according to the written instruction, a base section is formed.

16. The product as recited in claim 15 further comprising a plurality of anti-slip padding with adhesive backing, and wherein the instruction provides that the anti-slip padding may be adhere to the base section.

17. The product as recited in claim 16, wherein the board is a card board and has at least two creases of linear depression, the crease distinguishes the sections, making each of said sections pivotable in relation to an adjacent section.

18. The product as recited in claim 17 further comprising a least one tab extending from a distal end of the board and a slit opening in the base section.

19. The product as recited in claim 18 where the base section has a triangular prism when assembled for use.

20. The product as recited in claim 15, wherein at least one of the boards is covered in a different material than the material of the board, and at least one of the boards has ventilation holes.

21. The product as recited in claim 20, further comprising detachable attaching accessories, said accessories is at least one selected from:
a. pocket;
b. pen holder; and
c. cord wrapper.
